(19) United States
(12) Patent Application Publication
(10) Pub. No.: US 2026/0316106 A1
(43) Pub. Date: Oct. 15, 2026

(54) SYSTEM FOR AUTOMATIC ADJUSTMENT TO TARGET PRESSURE AND RELATED DEVICES AND METHODS

(71) Applicant: Ag Leader Technology, Ames, IA (US)

(72) Inventors: Tucker Gabriel, Ames, IA (US); Evan Bodermann, Ames, IA (US)

(21) Appl. No.: 19/467,539

(22) Filed: Feb. 2, 2026

Related U.S. Application Data
(60) Provisional application No. 63/752,279, filed on Jan. 31, 2025.

(51) Int. Cl. B05B 12/08; A01C 14/00; B05B 1/14; B05B 13/00

(52) U.S. Cl. CPC B05B 12/087; A01C 14/00; B05B 1/14; B05B 13/005

(57) ABSTRACT

Disclosed herein are various implementations related to a system for maintaining flow rates comprising a plurality of nozzles configured to spray a fluid, a pump configured to pump the fluid through the plurality of nozzles by imparting a pressure to the fluid, a pressure sensor configured to measure the pressure of the fluid, and a controller in electrical communication with the plurality of nozzles, the pump, and the pressure sensor, the controller configured to adjust the pressure of the fluid to maintain the pressure at or near a target.

### CROSS-REFERENCE TO RELATED APPLICATION(S)

This application claims the benefit under 35 U.S.C. § 119 (e) to U.S. Provisional Application 63/752,279, filed Jan. 31, 2025, and entitled System for Automatic Adjustment to Target Pressure and Related Devices and Methods, which is hereby incorporated herein by reference in its entirety for all purposes.

### TECHNICAL FIELD

The disclosure relates to agricultural spraying systems and to spraying systems with independently variable spray pressure and flow rate.

### BACKGROUND

There is a need in the art for maintaining a consistent spray rate, including when employing variable spray rate technologies in diverse field conditions. Various agricultural systems currently use a constantly maintained boom pressure to maintain a spray rate within a set range, but this range is limited by the nozzle duty cycle. In such systems, a user may need to adjust the boom target pressure manually to maintain consistent vehicle speed and spray rate quality, which can be challenging and requires attention to be taken from other aspects of spraying.

### BRIEF SUMMARY

Various implementations discussed herein relate to a system for maintaining precise, individualized nozzle flow rates without the need for manual adjustment of system pressure. In some of these implementations, the system may adjust the pressure according to prescription data that may be pre-loaded into the system. In such implementations, the prescription data can incorporate vehicle speed, known nozzle specifications, and other known parameters to calculate a precise target pressure and nozzle flow rate.
In Example 1, a system for maintaining flow rates comprising a plurality of nozzles configured to spray a fluid, at least one pump configured to pump the fluid through plumbing to the plurality of nozzles by imparting a pressure to the fluid, a pressure sensor configured to measure the pressure of the fluid, and a controller in electrical communication with the plurality of nozzles, the pump, and the pressure sensor, the controller configured to adjust the pressure of the fluid to maintain the pressure at or near a target pressure.
Example 2 relates to the system of any of Examples 1 and 3-7, further comprising a control valve in electronic communication with the controller and fluidic communication with the plurality of nozzles and pump.
Example 3 relates to the system of any of Examples 1-2 and 4-7, wherein the pressure is adjusted by actuation of the control valve.
Example 4 relates to the system of any of Examples 1-3 and 5-7, wherein the pressure is adjusted by adjusting a speed of the at least one pump.
Example 5 relates to the system of any of Examples 1~4 and 6-7, wherein the controller is configured to adjust the duty cycles of the plurality of nozzles to adjust the flow rate through each of the plurality of nozzles.
Example 6 relates to the system of any of Examples 1-5 and 7, wherein the plurality of nozzles are smart nozzles each comprising an integrated electronic control unit.
Example 7 relates to the system of any of Examples 1-6, wherein the target pressure is adjusted using one or more of a speed of a vehicle and a bearing of the vehicle.
In Example 8, an agricultural device comprising a plurality of nozzles configured to spray a fluid, a pump configured to pump the fluid through plumbing to the plurality of nozzles by imparting a pressure to the fluid, a control valve positioned along plumbing between the pump and the plurality of nozzles, and a controller in electrical communication with the plurality of nozzles, the pump, and the control valve, the controller configured to adjust the pressure of the fluid to maintain the pressure at or near a target pressure.
Example 9 relates to the agricultural device of any of Examples 8 and 10-14, further comprising a pressure sensor configured to measure the pressure of the fluid.
Example 10 relates to the agricultural device of any of Examples 8-9 and 11-14, wherein the pressure is adjusted by one or more of actuating the control valve and adjusting a speed of the pump.
Example 11 relates to the agricultural device of any of Examples 8-10 and 12-14, wherein the target pressure is selected based on one or more of a vehicle speed and a vehicle bearing.
Example 12 relates to the agricultural device of any of Examples 8-11 and 13-14, wherein the plurality of nozzles are smart nozzles each comprising an integrated electronic control unit.
Example 13 relates to the agricultural device of any of Examples 8-12 and 14, wherein the controller is configured to adjust the duty cycles of the plurality of nozzles to adjust the flow rate through each of the plurality of nozzles.
Example 14 relates to the agricultural device of any of Examples 8-13, wherein the controller is configured to make real-time adjustments to the pressure based on a prescription.
In Example 15, a system for spraying an agricultural field comprising a sprayer comprising a first boom and a second boom, each of the first boom and the second boom comprising a plurality of nozzles, plumbing connecting the plurality of nozzles, and a control valve along the plumbing, a pump in communication with the first boom and the second boom plumbing configured to impart a pressure on a fluid circulating through the plumbing; and a controller in electrical communication with the plurality of nozzles, the pump, and the control valves, the controller send commands configured to adjust the pressure of the fluid to maintain the pressure at or near a target pressure.
Example 16 relates to the system of any of Examples 15 and 17-20, wherein the pressure is adjusted by one or more of actuating the control valve and adjusting a speed of the pump.
Example 17 relates to the system of any of Examples 15-16 and 18-20, wherein the controller is configured to adjust the duty cycles of the plurality of nozzles to adjust the flow rate through each of the plurality of nozzles.
Example 18 relates to the system of any of Examples 15-17 and 19-20, wherein the controller is configured to make real-time adjustments to the pressure based on a prescription.
Example 19 relates to the system of any of Examples 15-18 and 20, wherein the target pressure is selected based on one or more of a vehicle speed and a vehicle bearing.
Example 20 relates to the system of any of Examples 15-19, wherein the first boom and the second boom are independently controlled.

A system of one or more computers or computing devices can be configured to perform particular operations or actions by virtue of having software, firmware, hardware, or a combination of them installed on the system that in operation causes the system to perform the actions. One or more computer programs can be configured to perform particular operations or actions by virtue of including instructions that, when executed by data processing apparatus, cause the apparatus to perform the actions.

While multiple embodiments are disclosed, still other embodiments of the disclosure will become apparent to those skilled in the art from the following detailed description, which shows and describes illustrative implementations of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF DRAWINGS

FIG. 1 is a diagram of the system mounted to a vehicle, according to one implementation.

FIG. 2 is a diagram of various system components, according to one implementation.

FIG. 3 is a diagram of the system, according to one implementation.

FIG. 4 is a diagram of the system in operation when the vehicle is turning, according to one implementation.

### DETAILED DESCRIPTION

The disclosed system provides an improvement in maintaining precise, individual flow rates for an agricultural sprayer. In various implementations, the system allows for maintaining individual flow rates for various nozzles of a sprayer, without the need to change the overall system pressure. In various implementations, the system is configured to apply fluids based on prescription data.

Certain of the disclosed implementations can be used in conjunction with any of the devices, systems or methods taught or otherwise disclosed in U.S. Pat. No. 10,684,305 issued Jun. 16, 2020, entitled “Apparatus, Systems and Methods for Cross Track Error Calculation From Active Sensors,” U.S. patent application Ser. No. 16/121,065, filed Sep. 4, 2018, entitled “Planter Down Pressure and Uplift Devices, Systems, and Associated Methods,” U.S. Pat. No. 10,743,460, issued Aug. 18, 2020, entitled “Controlled Air Pulse Metering apparatus for an Agricultural Planter and Related Systems and Methods,” U.S. Pat. No. 11,277,961, issued Mar. 22, 2022, entitled “Seed Spacing Device for an Agricultural Planter and Related Systems and Methods,” U.S. patent application Ser. No. 16/142,522, filed Sep. 26, 2018, entitled “Planter Downforce and Uplift Monitoring and Control Feedback Devices, Systems and Associated Methods,” U.S. Pat. No. 11,064,653, issued Jul. 20, 2021, entitled “Agricultural Systems Having Stalk Sensors and/or Data Visualization Systems and Related Devices and Methods,” U.S. Pat. No. 11,297,768, issued Apr. 12, 2022, entitled “Vision Based Stalk Sensors and Associated Systems and Methods,” U.S. patent application Ser. No. 17/013,037, filed Sep. 4, 2020, entitled “Apparatus, Systems and Methods for Stalk Sensing,” U.S. patent application Ser. No. 17/226,002 filed Apr. 8, 2021, and entitled “Apparatus, Systems and Methods for Stalk Sensing,” U.S. Pat. No. 10,813,281, issued Oct. 27, 2020, entitled “Apparatus, Systems, and Methods for Applying Fluid,” U.S. patent application Ser. No. 16/371,815, filed Apr. 1, 2019, entitled “Devices, Systems, and Methods for Seed Trench Protection,” U.S. patent application Ser. No. 16/523,343, filed Jul. 26, 2019, entitled “Closing Wheel Downforce Adjustment Devices, Systems, and Methods,” U.S. patent application Ser. No. 16/670,692, filed Oct. 31, 2019, entitled “Soil Sensing Control Devices, Systems, and Associated Methods,” U.S. patent application Ser. No. 16/684,877, filed Nov. 15, 2019, entitled “On-The-Go Organic Matter Sensor and Associated Systems and Methods,” U.S. Pat. No. 11,523,554, issued Dec. 13, 2022, entitled “Dual Seed Meter and Related Systems and Methods,” U.S. patent application Ser. No. 16/891,812, filed Jun. 3, 2020, entitled “Apparatus, Systems and Methods for Row Cleaner Depth Adjustment On-The-Go,” U.S. Pat. No. 11,678,607, issued Jun. 20, 2023, entitled “Apparatus, Systems, and Methods for Eliminating Cross-Track Error,” U.S. patent application Ser. No. 16/921,828, filed Jul. 6, 2020, entitled “Apparatus, Systems and Methods for Automatic Steering Guidance and Visualization of Guidance Paths,” U.S. Pat. No. 12,353,210, issued Jul. 8, 2025, entitled “Apparatus, Systems and Methods for Automated Navigation of Agricultural Equipment,” U.S. patent application Ser. No. 16/997,361, filed Aug. 19, 2020, entitled “Apparatus, Systems and Methods for Steerable Toolbars,” U.S. Pat. No. 11,785,881, issued Oct. 17, 2023, entitled “Adjustable Seed Meter and Related Systems and Methods,” U.S. patent application Ser. No. 17/011,737, filed Sep. 3, 2020, entitled “Planter Row Unit and Associated Systems and Methods,” U.S. Pat. No. 11,877,530 issued Jan. 23, 2024, entitled “Agricultural Vacuum and Electrical Generator Devices, Systems, and Methods,” U.S. patent application Ser. No. 17/105,437, filed Nov. 25, 2020, entitled “Devices, Systems and Methods For Seed Trench Monitoring and Closing,” U.S. patent application Ser. No. 17/127,812, filed Dec. 18, 2020, entitled “Seed Meter Controller and Associated Devices, Systems and Methods,” U.S. patent application Ser. No. 17/132,152, filed Dec. 23, 2020, entitled “Use of Aerial Imagery For Vehicle Path Guidance and Associated Devices, Systems, and Methods,” U.S. patent application Ser. No. 17/164,213, filed Feb. 1, 2021, entitled “Row Unit Arm Sensor and Associated Systems and Methods,” U.S. Pat. No. 12,268,115, issued Apr. 8, 2025, entitled “Planter Obstruction Monitoring and Associated Devices and Methods,” U.S. patent application Ser. No. 17/225,586, filed Apr. 8, 2021, entitled “Devices, Systems, and Methods for Corn Headers,” U.S. Pat. No. 11,758,848, issued Sep. 19, 2023, entitled “Devices, Systems, and Methods for Sensing the Cross Sectional Area of Stalks,” U.S. patent application Ser. No. 17/323,649, filed May 18, 2021, entitled “Assisted Steering Apparatus and Associated Systems and Methods,” U.S. patent application Ser. No. 17/369,876, filed Jul. 7, 2021, entitled “Apparatus, Systems, and Methods for Grain Cart-Grain Truck Alignment and Control Using GNSS and/or Distance Sensors,” U.S. patent application Ser. No. 17/381,900, filed Jul. 21, 2021, entitled “Visual Boundary Segmentations and Obstacle Mapping for Agricultural Vehicles,” U.S. patent application Ser. No. 17/461,839, filed Aug. 30, 2021, entitled “Automated Agricultural Implement Orientation Adjustment System and Related Devices and Methods,” U.S. Pat. No. 12,414,505, issued Sep. 16, 2025, entitled “Apparatus, Systems, and Methods for Row-by-Row Control of a Harvester,” U.S. patent application Ser. No. 17/526,947, filed Nov. 15, 2021, entitled “Agricultural High Speed Row Unit,” U.S. patent application Ser. No. 17/556,506, filed Dec. 20, 2021, entitled “Devices, Systems, and Method For Seed Delivery Control,” U.S. patent application Ser. No. 17/576,463, filed Jan. 14, 2022, entitled “Apparatus, Systems, and Methods for Row Crop Headers,” U.S. Pat. No. 12,403,950, issued Sep. 2, 2025, entitled “Automatic Steering Systems and Methods,” U.S. patent application Ser. No. 17/742,373, filed May 11, 2022, entitled “Calibration Adjustment for Automatic Steering Systems,” U.S. patent application Ser. No. 17/902,366, filed Sep. 2, 2022, entitled “Tile Installation System with Force Sensor and Related Devices and Methods,” U.S. patent application Ser. No. 17/939,779, filed Sep. 7, 2022, entitled “Row-by-Row Estimation System and Related Devices and Methods,” U.S. patent application Ser. No. 18/215,721, filed Jun. 28, 2023, entitled “Seed Tube Guard and Associated Systems and Methods of Use,” U.S. patent application Ser. No. 18/087,413, filed Dec. 22, 2022, entitled “Data Visualization and Analysis for Harvest Stand Counter and Related Systems and Methods,” U.S. patent application Ser. No. 18/097,804, filed Jan. 17, 2023, entitled “Agricultural Mapping and Related Systems and Methods,” U.S. patent application Ser. No. 18/101,394, filed Jan. 25, 2023, entitled “Seed Meter with Integral Mounting Method for Row Crop Planter and Associated Systems and Methods,” U.S. patent application Ser. No. 18/102,022, filed Jan. 26, 2023, entitled “Load Cell Backing Plate and Associated Devices, Systems, and Methods,” U.S. patent application Ser. No. 18/116,714, filed Mar. 2, 2023, entitled “Cross Track Error Sensor and Related Devices, Systems, and Methods,” U.S. patent application Ser. No. 18/203,206, filed May 30, 2023, entitled “Seed Tube Camera and Related Devices, Systems and Methods,” U.S. patent application Ser. No. 18/209,331, filed Jun. 13, 2023, entitled “Apparatus, Systems and Methods for Image Plant Counting,” U.S. patent application Ser. No. 18/217,216, filed Jun. 30, 2023, entitled “Combine Unloading On-The-Go with Bin Level Sharing and Associated Devices, Systems, and Methods,” U.S. patent application Ser. No. 18/229,974, filed Aug. 3, 2023, entitled “Hydraulic Cylinder Position Control for Lifting and Lowering Towed Implements,” U.S. patent application Ser. No. 18/230,534, filed Aug. 4, 2023, entitled “Single-Step Seed Placement in Furrow and Related Devices, Systems, and Methods,” U.S. patent application Ser. No. 18/238,344, filed Aug. 25, 2023, entitled “Combine Yield Monitor Automatic Calibration System and Associated Devices and Methods,” U.S. patent application Ser. No. 18/367,929, filed Sep. 13, 2023, entitled “Hopper Lid with Magnet Retention and Related Systems and Methods,” U.S. patent application Ser. No. 18/516,514, filed Nov. 21, 2023, entitled “Stalk Sensors and Related Devices, Systems, and Methods,” U.S. patent application Ser. No. 18/441,708, filed Feb. 14, 2024, entitled “Liquid Flow Meter and Flow Balancer and Associated Devices, Systems, and Methods,” U.S. patent application Ser. No. 18/662,800, filed May 13, 2024, entitled “Devices, Systems, and Methods for Providing Yield Maps,” U.S. patent application Ser. No. 18/665,305, filed May 15, 2024, entitled “Devices, Systems, and Methods for Agricultural Guidance and Navigation,” U.S. patent application Ser. No. 18/761,041, filed Jul. 1, 2024, entitled “Ring Assembly For Automatic and/or Assisted Steering and Associated Systems and Methods,” U.S. patent application Ser. No. 18/766,374, filed Jul. 8, 2024, entitled “Assisted Steering Systems and Associated Devices and Methods for Agricultural Vehicles,” U.S. patent application Ser. No. 18/929,309, filed Oct. 28, 2024, entitled “Agricultural Implement Position Sensor and Related Devices, Systems, and Methods,” U.S. patent application Ser. No. 18/962,799, filed Nov. 27, 2024, entitled “Devices, Systems and Methods for Guidance Line Shifting,” U.S. patent application Ser. No. 18/974,482, filed Dec. 9, 2024, entitled “Header Height Control Devices, Systems and Methods,” U.S. patent application Ser. No. 18/980,728, filed Dec. 13, 2024, entitled “Deck Plate Spacing Sensors and Related Devices, Systems, and Methods,” U.S. patent application Ser. No. 19/041,787, filed Jan. 30, 2025, entitled “Grain Cart Unloading Sensor and Unload Control System and Associated Devices and Methods,” U.S. patent application Ser. No. 19/207,115, filed May 13, 2025, entitled “Devices, Systems, and Methods for Planter and Seed Trench Imaging and Analysis,” U.S. patent application Ser. No. 19/219,718, fled May 27, 2025, entitled “Devices, Systems, and Methods for Agricultural Navigation and Positioning,” U.S. patent application Ser. No. 19/226,004, filed Jun. 2, 2025, entitled “Devices, Systems, and Methods for Machinery Monitoring and Reporting,” U.S. Patent Application 63/667,546, filed Jul. 3, 2024, entitled “Cover for Port Openings,” U.S. patent application Ser. No. 19/260,159, filed Jul. 3, 2025, entitled “Agricultural Seed Meters and Related Devices, Systems and Methods,” U.S. patent application Ser. No. 19/297,963, filed Aug. 12, 2025, entitled “Agricultural Navigation and Steering Systems, Devices and Methods,” U.S. patent application Ser. No. 19/305,530, filed Aug. 20, 2025, entitled “Crop Sensor Wands and Related Devices, Systems, and Methods,” U.S. patent application Ser. No. 19/366,202, filed Oct. 22, 2025, entitled “Crop Sensors and Related Devices, Systems, and Methods,” U.S. patent application Ser. No. 19/367,363, filed Oct. 23, 2025, entitled “Agricultural Sprayer Sensor and Related Devices, Systems, and Methods,” U.S. patent application Ser. No. 19/390,280, filed Nov. 14, 2025, entitled “Liquid Product Distribution for Agricultural Spraying Systems and Related Devices and Methods,” U.S. patent application Ser. No. 19/396,047, filed Nov. 20, 2025, entitled “Agricultural Harvesting Systems and Related Devices and Methods,” U.S. patent application Ser. No. 19/396,099, filed Nov. 20, 2025, entitled “Sprayer Nozzle Devices and Related Systems and Methods,” U.S. patent application Ser. No. 19/397,422, filed Nov. 21, 2025, entitled “Systems, Methods, and Devices for Increasing Machine Operating Range,” U.S. patent application Ser. No. 19/408,177, filed Dec. 3, 2025, entitled “Agricultural Guidance and Navigation System and Related Devices and Methods,” U.S. Patent Application 63/752,341, filed Jan. 31, 2025, entitled “Harvester Liquid Application System, Devices, and Methods,” U.S. Patent Application 63/753,258, filed Feb. 3, 2025, entitled “Agricultural Navigation Methods, Devices, and Systems,” U.S. Patent Application 63/753,201, filed Feb. 3, 2025, entitled “Agricultural Mapping and Related Devices, Systems, and Methods” U.S. Patent Application 63/755,675, filed Feb. 7, 2025, entitled “Remote Assistance for Agricultural Display Methods and Related Devices and Systems,” U.S. Patent Application 63/757,242, filed Feb. 11, 2025, entitled “Seed Meter,” U.S. Patent Application 63/757,434, filed Feb. 12, 2025, entitled “Grain Fill Sensor,” U.S. Patent Application 63/760,907, filed Feb. 20, 2025, entitled Agricultural Yield Monitoring and Estimation Devices, Systems, and Methods,” U.S. Patent Application 63/816,284, filed Jun. 2, 2025, entitled “Agricultural Guidance and Navigation Systems, Methods, and Devices,” U.S. Patent Application 63/817,692, filed Jun. 4, 2025, entitled “Intelligent Steering System for Sprayers and Tractors in Standing Crops,” U.S. Patent Application 63/818,248, filed Jun. 5, 2025, entitled “Devices, Systems, and Methods for Determining Implement Pose,” U.S. Patent Application 63/906,692, filed Oct. 28, 2025, entitled “Agricultural Alignment System and Related Devices and Methods,” U.S. Patent Application 63/906,646, filed Oct. 28, 2025, entitled “Automated Grail Filling System and Related Devices and Methods,” U.S. Patent Application 63/967,084, filed Jan. 23, 2025, entitled “System and Methods of Row-by-Row Yield Monitoring,” U.S. Patent Application 63/966,976, filed Jan. 23, 2025, entitled “Dispatch Indicator Calibration,” and U.S. Patent Application 63/967,038, filed Jan. 23, 2025, entitled “Grain Fill Sensor and Related Devices, Systems, and Methods,” each of which is incorporated herein by reference.

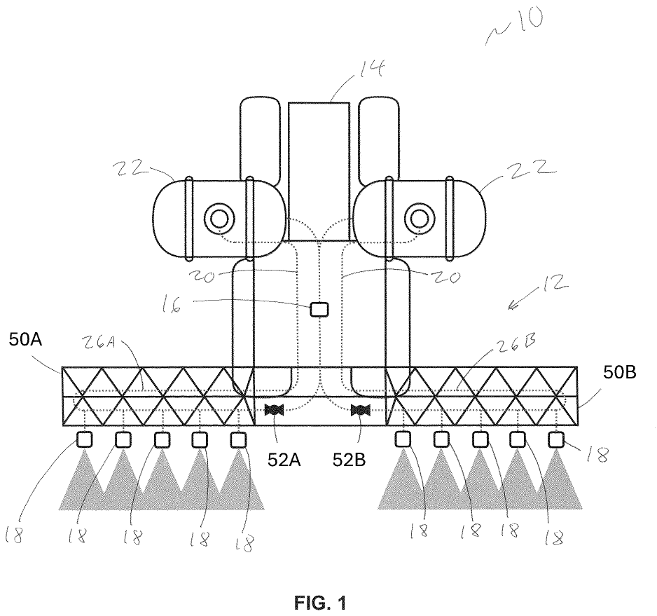

Turning now to the figures in more detail, FIG. 1 shows the system 10 that in various implementations may employ a sprayer 12, such as, but not limited to, an agricultural sprayer 12 used to apply fertilizers, pesticides, herbicides, and the like to crop fields. In the specific implementation shown in FIG. 1, the sprayer 12 is mounted onto a vehicle 14. However, in various other implementations contemplated within the system 10, the sprayer 12 may be free-standing and configured to be towed, as would be known and appreciated by those of skill in the art.

In various implementations, the system 10 sprayer 12 may use one or more pumps 16 in fluidic communication with a plurality of nozzles 18 through hoses 20 and other plumbing. In these and other implementations, the nozzles 18 are configured to allow or disallow the flow of fluid through each nozzle 18. As would be understood, each nozzle 18 may cycle between allowing and disallowing the flow of fluid. The percentage of time where each nozzle 18 is allowing fluid flow may be referred to as the duty cycle of that nozzle 18.

In various implementations, the nozzles 18 may be smart nozzles 18 and each may contain an integrated electronic control unit (ECU) 19. In other implementations, the nozzles 18 may be smart nozzles 18 that share an electronic control unit 19, such as a controller 32 (discussed below).

The pump 16 or pumps 16 may also be in fluidic communication with one or more tanks 22 through the hoses 20, where the tanks 22 may be configured to hold a liquid to be applied by the system 10. In some implementations, the nozzles 18 may be spaced along one or more booms 24A, 24B, which may be structures extending laterally to the sides of the sprayer 12, as would be generally understood. Various configurations for agricultural sprayers 12 and components thereof are known and would be understood by those of skill in the art.

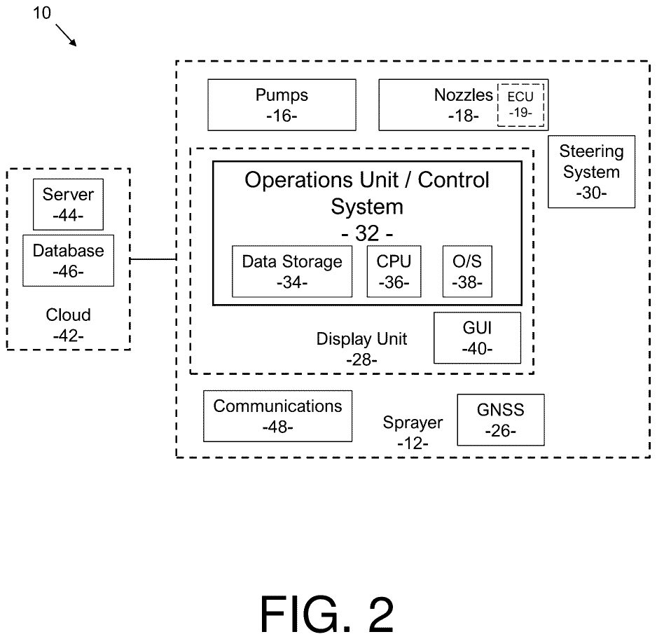

In various implementations, the system 10 includes a GNSS or GPS receiver 26 in operational communication with a vehicle system display 28, such as the InCommand® display from Ag Leader®, and an operations unit 32, as is shown in greater detail in FIG. 2. The system 10 optionally comprises various additional sensors, monitors and the like, as would be appreciated by those of skill in the art and as disclosed in various of the incorporated references.

The system 10 further optionally includes an automatic and/or assisted steering system 30. As would be understood, various automatic and/or assisted steering systems 30 are configured to take inputs from an operations unit 32 navigate a vehicle through a field. Various steering systems 30 may manually and/or electronically manipulate the systems on board a sprayer 12 and/or vehicle 14 to effectuate automatic and/or assisted steering, as would be appreciated by those of skill in the art. In various implementations, the automatic/assisted steering system 30 allows for autonomous navigation.

Continuing with FIGS. 1 and 2, in various implementations, the system 10 includes an operations unit 32, optionally integrated within the display 28, in operational communication with data link 48 (also referred to herein as a communications component 48). It is generally understood that these components may optionally be housed within the display unit 28 and that the representation of FIG. 2 is merely exemplary.

In certain implementations, the operations unit 32 is also configured for the sending and receiving of data for storage and processing, such as to the cloud 42, a remote server 44, database 46, and/or other cloud computing components readily understood in the art. Such connections by the operations unit 32, can be made wirelessly via understood internet and/or cellular technologies such as Bluetooth, Wi-Fi, LTE, 3G, 4G, or 5G connections, and the like. It is understood that in certain implementations, the operations unit 32 and/or cloud 42 component may comprise encryption or other data privacy components such as hardware, software, and/or firmware security aspects.

Continuing with FIG. 2, the operations unit 32, according to certain implementations, further has one or more optional processing and computing components, such as data storage 34, a CPU or processor 36, an operating system (“O/S”) 38, and other computing components necessary for implementing the various technologies disclosed herein. It is appreciated that the various optional system components are in operational communication with one another via wired or wireless connections and are configured to perform the processes and execute the commands described herein. As would be understood, each of these components can be located optionally at various locations around the vehicle or elsewhere, such as in the cloud 42 and accessible by a wireless or cellular connection.

In various implementations, this connectivity means that an operator, enterprise manager, and/or other third party is able to receive notifications such as adjustment prompts and confirmation screens on their mobile devices or via another access point. In certain implementations, these individuals can review the various data collected or recorded by the system 10 and make adjustments, comments, and/or observations in real-time or near real-time, as would be readily appreciated.

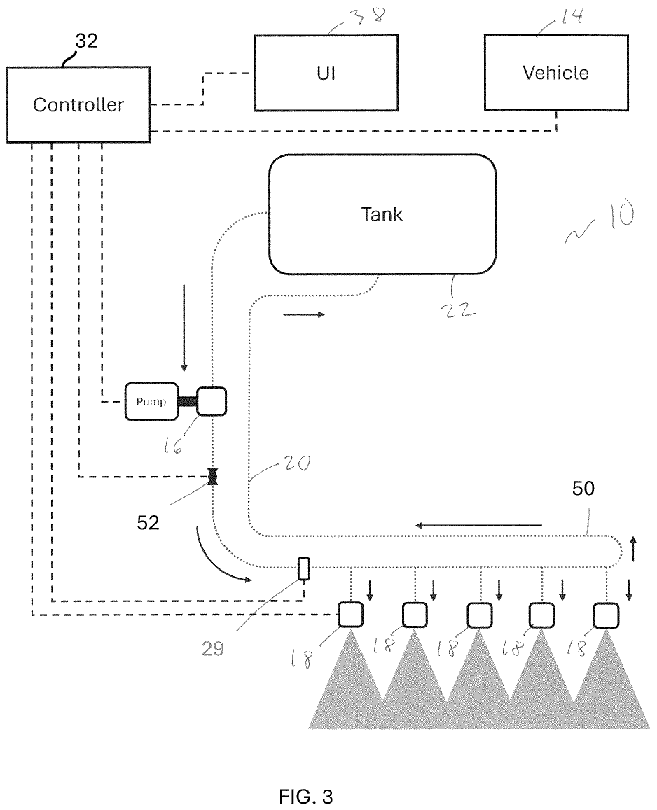

FIG. 3 shows a schematic diagram of certain components of the sprayer 12 independent of the vehicle 14 and booms 24A, 24B. In various implementations of the system 10, the pump 16 may draw a fluid from the tank 22 and pressurize the fluid within the hoses 20. The fluid may then flow through the hoses 20, with a portion of the fluid exiting through the nozzles 18, and return to a tank 12, forming a loop 50. The sprayer 12 may have more than one loop 50A, 50B, optionally one for each side of the sprayer 12 boom 24A, 24B (shown for example in FIG. 1). In other implementations, the sprayer 12 may use a single loop 50 that spans the length of the booms 24A, 24B.

The pressure of the fluid within the hoses 20 may be measured by a pressure sensor 29. The pressure sensor 29 may optionally be in electronic communication with a controller 32, which may be configured to receive data, process data, and output signals to connected components, as discussed above in reference to FIG. 2.

Continuing with FIG. 3, in various implementations, the sprayer 12 may have a control valve 52 in fluidic communication with the hoses 20 and in electronic communication with the controller 32. In various implementations, the sprayer 12 may control the pressure within the hoses 20 by adjusting the control valve 52. The sprayer 12 may also control the pressure within the hoses 20 by adjusting the speed of the pump 16. The sprayer 12 may also use a combination of adjustments in the speed of the pump 16 and the position of the control valve 52, as would be appreciated.

In certain implementations, such as shown in FIG. 1, the system 10 may use two control valves 52A, 52B and a single pump 16 to be able to independently adjust the pressure in each loop 50A, 50B or section of the boom 24. Alternatively, two control valves 52A, 52B and more than one pump 16, for instance two pumps, may be used to independently adjust the pressure in each loop 50A, 50B. In other implementations, two pumps may be used without the use of control valves 52, 52A, 52B to independently adjust the pressure in each loop 50A, 50B. As would be understood, the independent adjustment of pressure between different loops 50A, 50B may be critical in situations where flow from the nozzles 18 on one loop 50A, 50B may need to be higher or lower than the nozzles 18 on another loop 50B, 50A, such as while spraying during a turn of the implement 12, 14. That is, various section of the sprayer 12 may need to different flow rates during different operations.

Turning back to FIG. 3, in various implementations, each of the plurality of nozzles 18 may be in electronic communication with the controller 32. In such implementations, the nozzles 18 may be opened and closed by signals sent by the controller 32.

In some implementations, the controller 32 may be in electronic communication with the vehicle 14. In these implementations, the controller 32 may be able to detect the speed and direction of the vehicle 14 through the electronic communications between the controller 32 and vehicle 14, such as when the vehicle 14 is being driven/operated by an automatic or assisted steering system 30, as would be generally understood by those of skill in the art.

In various implementations, the controller 32 may be configured to change the duty cycle—the amount of time spent open—of each nozzle 18 in order to adjust the flow rate of fluid through each nozzle 18. As would be understood, as the duty cycle of each nozzle 18 may be limited by certain mechanical limitations, the flow rate of fluid through each nozzle 18 will likewise be limited for any given operating pressure. For instance, a nozzle 18 may not be able to operate effectively with less than a 20% duty cycle, due to the speed of actuation of the nozzle 18 or due to concerns about the quality and consistency of fluid spray. Similarly, a nozzle 18 cannot have a duty cycle above 100%, limiting the flow rate through the nozzle to its maximum flow capacity for a given operating pressure. These duty cycle thresholds are meant to be exemplary of a concept and are not intended to be limiting to any particular range.

In various implementations, the flow rate through each nozzle 18 may be limited by the duty cycle of each nozzle 18, the controller 32 may adjust the pressure of each loop 50A, 50B to achieve flow rates not attainable at the initial pressure.

The controller 32, in some implementations, may make prescription-based measurement adjustments. Prescription-based measurement adjustments may require that a target vehicle 14 speed be manually input into the controller 32. The system 10 may then automatically adjust the fluid pressure in the loops 50A, 50B to ensure the desired flow rates are achieved, given the duty cycles of the nozzles 18.

The controller 32, in other implementations, may make real-time measurement adjustments. Real-time measurement adjustments may require the controller 32 to be in electronic communication with the vehicle 14 in order to receive real-time data about the speed and bearing of the vehicle 14. In various implementations, the controller 32 may use the speed of the vehicle 14 as a basis for adjusting the pressure in the loops 50A, 50B. As an example, if the vehicle 14 speed increases, the pressure in the loops 50A, 50B may be increased to maintain the same quantity of fluid sprayed on each portion of crops passing under the nozzles 18.

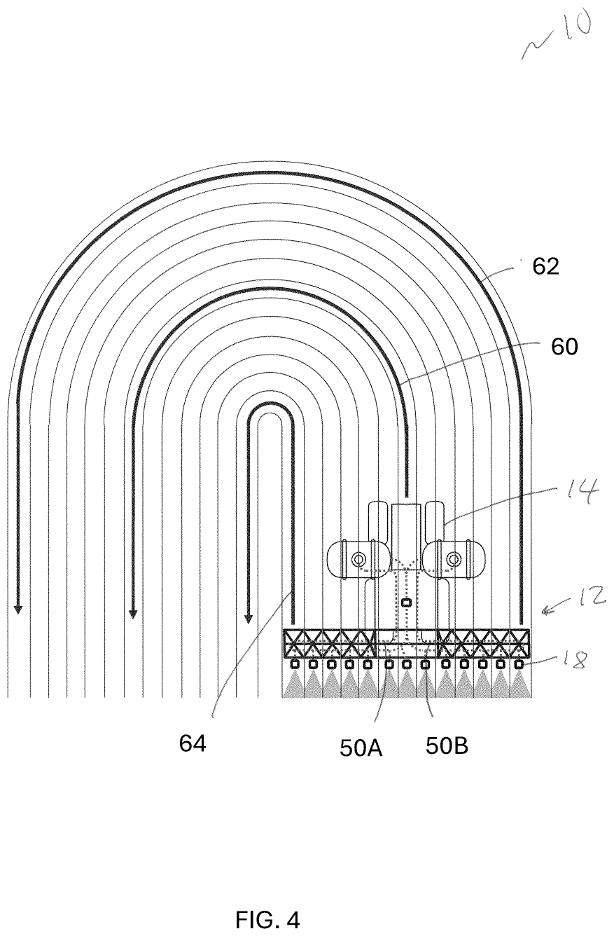

Turning now to FIG. 4, the controller 32 may use the bearing of the vehicle 14 as a basis for adjusting the pressure in the loops 50A, 40B. As an example, if the vehicle 14 turns, the controller 32 may increase the pressure in the loop 50B on the outside 62 of the curved path 60 of the vehicle 14 and decrease the pressure in the loop 50A on the inside 64 of the curved path 60 of the vehicle 14. As those in the art would understand, this may be beneficial in applying an even amount of fluid, as the loop 50B on the outside 62 of the curved path 60 of the vehicle 14 moves faster and covers a greater area than the loop 50A on the inside 64 of the curved path 60 of the vehicle 14.

In various implementations, the duty cycle of individual nozzles 18 within each loop 26 may be adjusted to ensure differences between the relative speed of each nozzle 18 are accounted for. The adjustment of the pressure of each loop 26 may assist in this, as particularly tight turns or large booms 24 may lead to the nozzles 18 at opposite ends of the booms 24A, 24B to need flow rates that are not achievable by variation of the duty cycle of the nozzles 18 alone. In specific implementations where the pressure in the loops 26A, 26B is held about at a baseline pressure when the vehicle 14 is traveling in a straight line, the nozzle 18 that is on the most outside 32 section of the curved path 34 of the vehicle 14 may not be able to achieve the desired flow rate at the baseline pressure. In such implementations, the controller 30 may increase the pressure of the loop 26B on the outside 32 above the baseline pressure to allow the outermost nozzle 18 to reach the desired flow rate.

Similarly, in such implementations where the pressure in the loops 50A, 50B is held about at a baseline pressure when the vehicle 14 is traveling in a straight line, the nozzle 18 that is on the most inside 64 section of the curved path 60 of the vehicle 14 may not be able to achieve the desired flow rate at the baseline pressure without sacrificing spray quality and consistency. In such implementations, the controller 32 may decrease the pressure of the loop 50A on the inside 64 above the baseline pressure to allow the innermost nozzle 18 to function consistently at the desired flow rate.

In various implementations, the ability for the system 10 to adjust the pressure of the loops 50A, 50B may also allow for more variation in speeds of the vehicle 14 while maintaining desired flow rates. As would be understood, due to the limitations in the duty cycle of the nozzles 18, the speed of the vehicle 14 must be maintained within a certain range to ensure the desired fluid flow onto each parcel of crops is maintained. In various implementations of the system 10, the pressure of each loop 50A, 50B may be decreased to allow for slower vehicle 14 speeds or may be increased to allow for faster vehicle 14 speeds.

Turning back to FIGS. 2-3, in various implementations of the system 10, the controller 32 may be in electronic communication with a user interface (“UI”) 38. In various implementations, the UI 38 may be used to input target flow rates, expected vehicle speeds, physical fluid parameters, and other such information that may be needed for operation of the system 10. In various implementations, the UI 38 may also return information to the operator of the system 10, such as current and average loop 40 pressures, current and average nozzle 18 flow rates, differences in loop 50 pressure when the sprayer 12 has more the one loop 50A, 50B, and various other metrics that would be known and appreciated by those of skill in the art.

In some implementations, the UI 38 may be used to toggle between different operating modes, such as between using prescription-based measurements adjustments, real-time measurements adjustments, running without any assistance from the system 10, or various other operating modes that would be known to those in the art.

In various implementations, the system 10 and controller 32 may use any known method to calculate the adjustments used in the system 10. In some specific implementations, the system 10 may calculate a liquid density conversion factor, abbreviated as F. In these implementations, the liquid density conversion factor may be calculated according to Equation 1, where X is the weight of the fluid in pounds per US gallon.

$$F = \sqrt{\frac{X}{8.34}} \qquad Equation 1$$

In some specific implementations, the system 10 may calculate a relationship between fluid flow rates fluid pressure according to Equation 2, where GPM is the fluid flow rate for each nozzle 18 measured in US gallons per minute and PSI is the fluid pressure at each nozzle 18.

$$\frac{G P {M}_{1}}{G P {M}_{2}} = \sqrt{\frac{P S {I}_{1}}{P S {I}_{2}}} \qquad Equation 2$$

In some implementations, the system 10 may calculate flow rate needed through the nozzles 18 based on the speed of the vehicle 14 according to Equation 3, where GPA is the application rate of the fluid, measured in gallons per acre, MPH is the speed of the vehicle 14, measured in miles per hour, W is the spacing of the nozzles 18 measured in inches, and GPM is the fluid flow rate measured in gallons per minute per nozzle 18.

$$G P M = \frac{G P A \times M P H \times W}{5940} \qquad Equation 3$$

These calculations are meant to be exemplary and are not intended to limit the system 10 to any specific calculations or methods.

Although the disclosure has been described with reference to preferred embodiments, persons skilled in the art will recognize that changes may be made in form and detail without departing from the spirit and scope of the disclosed apparatus, systems and methods.

What is claimed is:

1. A system for maintaining flow rates comprising:
a plurality of nozzles configured to spray a fluid;
at least one pump configured to pump the fluid through plumbing to the plurality of nozzles by imparting a pressure to the fluid;
a pressure sensor configured to measure the pressure of the fluid; and
a controller in electrical communication with the plurality of nozzles, the pump, and the pressure sensor, the controller configured to adjust the pressure of the fluid to maintain the pressure at or near a target pressure.

2. The system of claim 1, further comprising a control valve in electronic communication with the controller and fluidic communication with the plurality of nozzles and pump.

3. The system of claim 2, wherein the pressure is adjusted by actuation of the control valve.

4. The system of claim 1, wherein the pressure is adjusted by adjusting a speed of the at least one pump.

5. The system of claim 1, wherein the controller is configured to adjust the duty cycles of the plurality of nozzles to adjust the flow rate through each of the plurality of nozzles.

6. The system of claim 1, wherein the plurality of nozzles are smart nozzles each comprising an integrated electronic control unit.

7. The system of claim 1, wherein the target pressure is adjusted using one or more of a speed of a vehicle and a bearing of the vehicle.

8. An agricultural device comprising:
a plurality of nozzles configured to spray a fluid;
a pump configured to pump the fluid through plumbing to the plurality of nozzles by imparting a pressure to the fluid;
a control valve positioned along plumbing between the pump and the plurality of nozzles; and
a controller in electrical communication with the plurality of nozzles, the pump, and the control valve, the controller configured to adjust the pressure of the fluid to maintain the pressure at or near a target pressure.

9. The agricultural device of claim 8, further comprising a pressure sensor configured to measure the pressure of the fluid.

10. The agricultural device of claim 8, wherein the pressure is adjusted by one or more of actuating the control valve and adjusting a speed of the pump.

11. The agricultural device of claim 9, wherein the target pressure is selected based on one or more of a vehicle speed and a vehicle bearing.

12. The agricultural device of claim 8, wherein the plurality of nozzles are smart nozzles each comprising an integrated electronic control unit.

13. The agricultural device of claim 8, wherein the controller is configured to adjust the duty cycles of the plurality of nozzles to adjust the flow rate through each of the plurality of nozzles.

14. The agricultural device of claim 8, wherein the controller is configured to make real-time adjustments to the pressure based on a prescription.

15. A system for spraying an agricultural field comprising:
(a) a sprayer comprising a first boom and a second boom, each of the first boom and the second boom comprising:
(i) a plurality of nozzles;
(ii) plumbing connecting the plurality of nozzles; and
(iii) a control valve along the plumbing;
(b) a pump in communication with the first boom and the second boom plumbing configured to impart a pressure on a fluid circulating through the plumbing; and
(c) a controller in electrical communication with the plurality of nozzles, the pump, and the control valves, the controller send commands configured to adjust the pressure of the fluid to maintain the pressure at or near a target pressure.

16. The system of claim 15, wherein the pressure is adjusted by one or more of actuating the control valve and adjusting a speed of the pump.

17. The system of claim 15, wherein the controller is configured to adjust the duty cycles of the plurality of nozzles to adjust the flow rate through each of the plurality of nozzles.

18. The system of claim 15, wherein the controller is configured to make real-time adjustments to the pressure based on a prescription.

19. The system of claim 15, wherein the target pressure is selected based on one or more of a vehicle speed and a vehicle bearing.

20. The system of claim 15, wherein the first boom and the second boom are independently controlled.
